(19) United States
(12) Patent Application Publication
(10) Pub. No.: US 2005/0047069 A1
(43) Pub. Date: Mar. 3, 2005

(54) Universal entertainment system

(76) Inventor: Chih Hui Chu, Elmhurst, NY (US)

Correspondence Address: Raymond Y. Chan, 108 N. Ynez Ave., Suite 128, Monterey Park, CA, 91754, US

(21) Appl. No.: 10/956,604

(22) Filed: Oct. 1, 2004

(51) Int. Cl. G06F 1/16

(52) U.S. Cl. 361/681; 312/223.1

(57) ABSTRACT

A universal entertainment system includes an entertainment unit, a universal mounting stand, and a folding joint. The entertainment unit includes an entertainment housing having a multimedia compartment, a display screen provided on a screen side, and a multi-functional multimedia circuitry disposed in the multimedia compartment for reading digital data of a multimedia. The universal mounting stand is adapted for supporting at a fixture surface. The folding joint pivotally connects the entertainment unit with the universal mounting stand in a rotatably movable manner, wherein the entertainment unit is adapted to pivotally fold with respect to the universal mounting stand to selectively adjust a tilt angle of the display screen with respect to the fixture surface and is adapted to rotatably fold with respect to the universal mounting stand to selectively adjust a revolving angle with respect to the universal mounting stand.

### BACKGROUND OF THE PRESENT INVENTION

1. Field of Invention

The present invention relates to an entertainment device, and more particularly to a universal entertainment system which is adapted to be mounted at a selected revolving angle so as to provide optimal display orientation when displaying multimedia.

2. Description of Related Arts

With the advance of information technology, domestic video players have been widely installed for playing such multimedia materials as movies, music videos, karaoke and the likes. These video devices obviously have a lot of advantages. For example, a movie can be shared among all family members during a particular family function, such as during a birthday party, without the trouble of attending a theatre at fixed time slots. Moreover, those restrictions generally adopted in a typical theatre, such as prohibition of external foods, can be avoided.

Despite the demand for a convenient and affordable domestic scale video device, there are several discrepancies among the relevant conventional arts. First of all, almost all video devices of this kind utilize domestic televisions as display screens for displaying the relevant multimedia materials. The major problem is that domestic television is usually bulky and difficult to adjust viewing angle.

In recent years, portable video players have been developed in which the users are able to carry them to outdoors environments and playing multimedia materials wherever and whenever they like. A major advantage for these portable video devices is that they are extremely flexible and rather convenient, and users usually prefer to have one during long journey.

A typical portable video device usually comprises a base panel, a display panel pivotally mounted with the base panel in an edge-to-edge manner, and a display screen provided on an inner side of the display panel. The display panel is adapted to fold between a folded position and an unfolded position, wherein at the folded position, the display panel is pivotally folded to overlap with the base panel so as to form a compact structure while the display screen is substantially protected between the base panel and the display panel. Conversely, when the display panel is at the unfolded position, it is pivotally folded to erect on the base panel for displaying multimedia materials at the display screen.

Despite its convenience, a major discrepancy for this type of portable video devices is that the viewing angle is often to narrow so that only limited number of people may be able to watch the multimedia materials the display screen. Moreover, since the display panel can only be folded with respect to the base panel, its limited viewing angle may make any attempt to mount the base panel with a fixture practically meaningless. For example, one may easily mount the base panel on a ceiling, however, by doing so, the display panel may be so oriented that people may not be able to view the at the display screen.

Another discrepancy for conventional portable video device is that electrical connections between the base panel and the display panel may be deteriorated through multiple folding and unfolding of the display panel.

### SUMMARY OF THE PRESENT INVENTION

A main object of the present invention is to provide a universal entertainment system which is adapted to be mounted at a selected revolving angle so as to provide optimal display orientation when displaying multimedia materials.

Another object of the present invention is to provide a universal entertainment system comprising an entertainment unit which is pivotally mounted on a universal mounting stand at two degree of freedom, so that it can be adjusted to achieve the optimal display orientation of a display screen.

Another object of the present invention is to provide a universal entertainment system which does not involve electrical connection between the entertainment unit and the universal mounting stand so that during folding and unfolding of the entertainment system with respect to the universal mounting stand, electrical connection within the universal entertainment system would not be deteriorated.

Another object of the present invention is to provide a universal entertainment system which is adapted to process a wide variety of multimedia materials in a single multimedia unit while having the flexibility of adjusting the optimal display orientation. In other words, the present invention may replace several multimedia players of different kinds in one single unit with enhanced flexibility and displaying quality, especially in outdoors environment.

Another object of the present invention is to provide a universal entertainment system which is adapted to mount on a wide variety of fixtures while maintaining the maximum degree of freedoms of the display screen, so that the present invention can be perfectly utilized in a wide variety of different functions and circumstances.

Another object of the present invention is to provide a universal entertainment system which does not involves complicated mechanical and electrical components so as to minimize the manufacturing cost and the ultimate selling price of the present invention.

Accordingly, in order to accomplish the above objects, the present invention provides a universal entertainment system, comprising:
an entertainment unit which comprises an entertainment housing having a multimedia compartment and a screen side, a display screen provided on the screen side of the entertainment housing, and a multi-functional multimedia circuitry which is disposed in the multimedia compartment and comprising a multimedia reader for reading digital data of a multimedia when the multimedia is received in the multimedia compartment so as to display the digital data of the multimedia as a video image on the display screen; and
a universal mounting stand adapted for supporting at a fixture surface; and
a folding joint pivotally connecting the entertainment unit with the universal mounting stand in a rotatably movable manner, wherein the entertainment unit is adapted to pivotally fold with respect to the universal mounting stand to selectively adjust a tilt angle of the display screen with respect to the fixture surface and is adapted to rotatably fold with respect to the universal mounting stand to selectively adjust a revolving angle with respect to the universal mounting stand such that the entertainment unit is adapted to selectively adjust an optimal display orientation of the display screen with respect to the fixture surface.

These and other objectives, features, and advantages of the present invention will become apparent from the following detailed description, the accompanying drawings, and the appended claims.

### BRIEF DESCRIPTION OF THE DRAWINGS

FIG. 1A is a perspective view of a universal entertainment system according to a preferred embodiment of the present invention.

FIG. 1B is another perspective view of a universal entertainment system according to the above preferred embodiment of the present invention.

FIG. 2 is an exploded perspective view of the universal entertainment system according to the above preferred embodiment of the present invention.

FIG. 3 is a schematic diagram of an application of the universal entertainment system according to the above preferred embodiment of the present invention.

FIG. 4A to FIG. 4D are schematic diagrams of the operations of the universal entertainment system according to the above preferred embodiment of the present invention.

### DETAILED DESCRIPTION OF THE PREFERRED EMBODIMENT

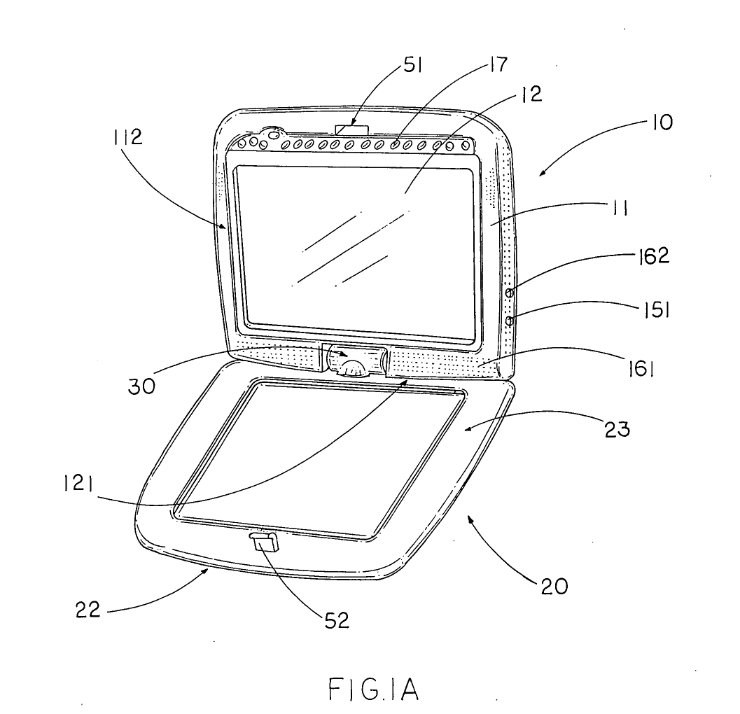

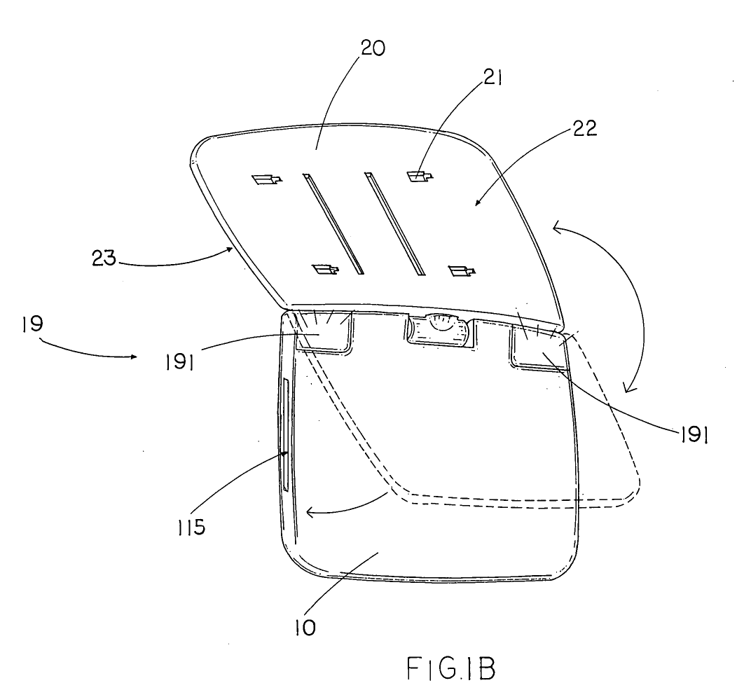

Referring to FIG. 1A of the drawings, a universal entertainment system according to a preferred embodiment of the present invention is illustrated, in which the universal entertainment system comprises an entertainment unit 10, a universal mounting stand 20 adapted for supporting at a fixture surface 121, and a folding joint 30.

The entertainment unit 10 comprises an entertainment housing 11 having a multimedia compartment and a screen side 112, a display screen 12 provided on the screen side 112 of the entertainment housing 11, and a multi-functional multimedia circuitry 13 which is disposed in the multimedia compartment and comprises a multimedia reader 131 for reading digital data of a multimedia when the multimedia is received in the multimedia compartment so as to display the digital data of the multimedia as a video image on the display screen 12. According to the preferred embodiment, the multimedia may be VCD or DVD which contain such typical multimedia materials as movies, or karaoke videos.

The folding joint 30 pivotally connects the entertainment unit 10 with the universal mounting stand 20 in a rotatably movable manner, wherein the entertainment unit 10 is adapted to pivotally fold with respect to the universal mounting stand 20 to selectively adjust a tilt angle of the display screen 12 with respect to the fixture surface, and is adapted to rotatably fold with respect to the universal mounting stand 20 to selectively adjust a revolving angle with respect to the universal mounting stand 20 such that the entertainment unit 10 is adapted to selectively adjust an optimal display orientation of the display screen 12 with respect to the fixture surface 121.

According to the preferred embodiment of the present invention, the entertainment housing 11 and the mounting stand 20 is made of durable yet light materials, such as aluminum alloy.

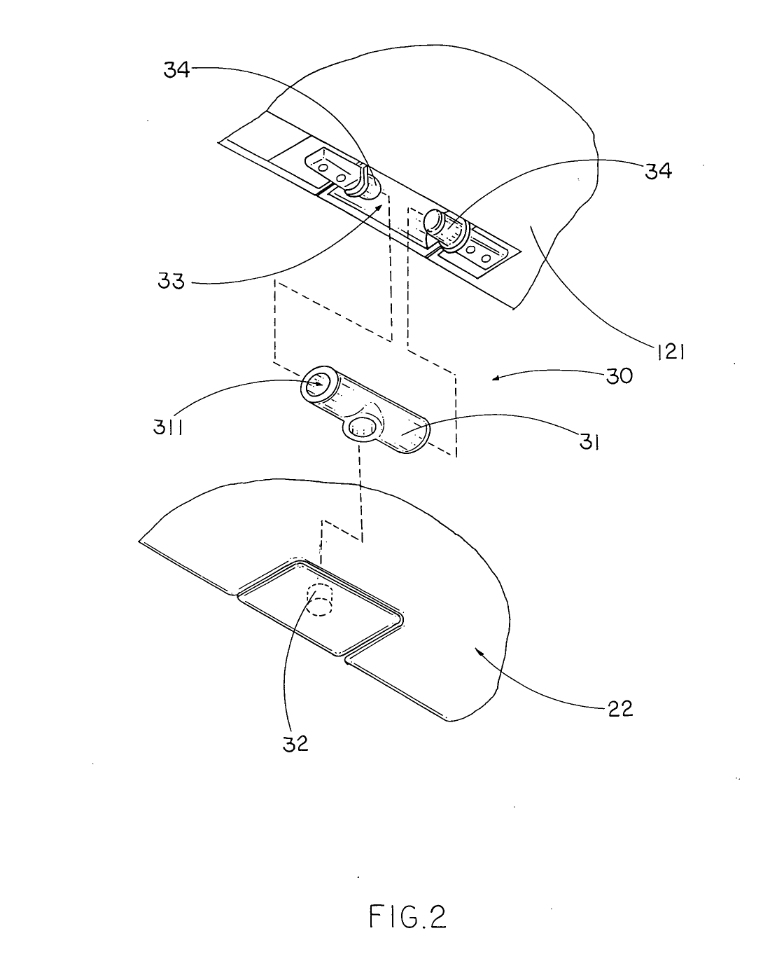

Referring to FIG. 1A and FIG. 2 of the drawings, the universal mounting stand 20 has a mounting side 22 for mounting on the fixture surface 121 and an opposed covering side 23 sized at least larger than a size of the display screen 12 such that the universal mounting stand 20 also forms as a protective cover pivotally folded to overlap the covering side 23 thereof on the screen side 112 of the entertainment housing to enclose the display screen 12 so as to protect the display screen 12 from exposing to outside.

In order to pivotally connect with the universal mounting stand 20 through the folding joint 30, the folding joint 30 has a folding slot 33 indently formed at a bottom side edge of the entertainment housing 10, and comprises two pivot shafts 34 transversely extended from two sidewalls of the folding slot 33.

Accordingly, the folding joint 30 further comprises a joint body 31 having two holding grooves 311 formed at two sides thereof respectively wherein the two pivot shafts 34 of the entertainment housing 11 are arranged to pivotally and frictionally connect with the two holding grooves 311 respectively in such a manner that the entertainment housing 11 and the folding joint 30 are capable of pivotally moving with respect to each other.

In other words, the joint body 30 is provided at a corresponding side edge of the universal mounting stand 20 and is rotatably engaged with the folding slot 33 to pivotally connect the universal mounting stand 20 with the entertainment housing 10 so as to selectively adjust the tilt angle between the display screen 12 and the universal mounting stand 20.

On the other hand, the folding joint 30 further comprises a revolving connector 32 extended from the corresponding side edge of the universal mounting stand 20 to transversely engage with the joint body 31 in a rotatably movable manner so as to rotatably connect the universal mounting stand 20 with the entertainment housing 10 to selectively adjust a revolving angle thereof with respect to the universal mounting stand 20.

Thus, it is important to realize that the folding joint 30 movably connects the entertainment unit 10 with the universal mounting stand 20 with two degrees of freedom, namely, a lateral pivotal movement between the entertainment unit 10 and the universal mounting stand 20 for defining the tilt angle therebetween, and a lateral rotational movement between the entertainment unit 10 and the universal mounting stand 20 for defining the revolving angle of the entertainment unit 10. The tilt angle and the revolving angle together form the optimal orientation of the display screen 12. Note that the lateral rotational movement of the entertainment unit 10 can be as much as 360 degrees with respect to the universal mounting stand 20 so as to maximize the flexibility of the adjustment of the revolving angle.

Accordingly, in order to fold the universal mounting stand 20 from the screen side 112 of the entertainment unit 10 to a rear side thereof, the universal mounting stand 20 is pivotally folded at a position perpendicular to the entertainment unit 10. Then, the universal mounting stand 20 is rotatably folded at 180 degrees with respect to the entertainment unit 10 such that the universal mounting stand 20 is adapted to pivotally fold towards the rear side of the entertainment unit 10, as shown in FIG. 1B. It is worth to mention that the mounting side 22 of the universal mounting stand 20 functions as an outer protecting side while the covering side 23 of the universal mounting stand 20 is overlapped on either the screen side 112 of the entertainment unit 10 or a rear side thereof.

Therefore, by adjusting a suitable tilt angle and the revolving angle, a user is able to selectively adjust an optimal orientation for the display screen 12 when the universal entertainment is utilized in different circumstances and mounted on different fixtures. For instances, when the universal entertainment system is mounted on a car's ceiling, the tilt angle and the revolving angle may have to be adjusted for displaying particular multimedia materials to particular passengers in the car.

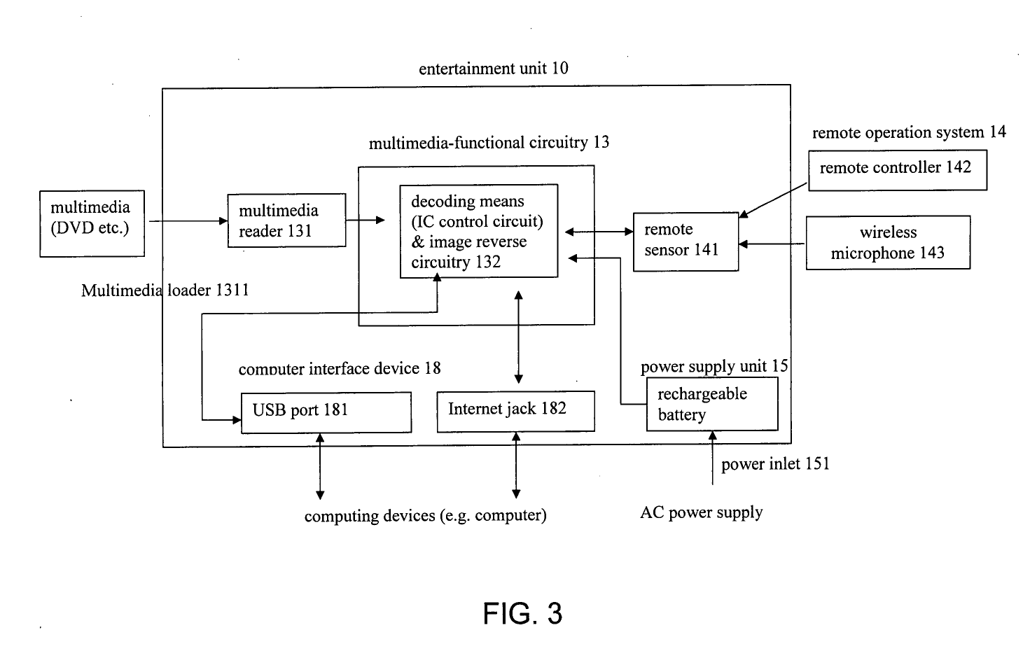

Referring to FIG. 3 of the drawings, the entertainment unit 10 is meant to process a wide variety of multimedia materials so as to form an all-rounded entertainment system. In light of this objective, the multi-functional multimedia circuitry 13 further comprises means for decoding digital multimedia data read from the multimedia reader 131 so as to display the multimedia data at the display screen 12. The decoding means is preferably embodied as typical IC control circuit for decoding VCD data, DVD data, TV signals (NTSC/PAL, Channel: VHF-12, UHF 13-69, CATV), radio signal (AM/FM), cable TV signal, as well as karaoke audio signal. Thus, one universal entertainment system can be used for displaying a wide variety of multimedia materials, so that the need to install several multimedia players for playing each particular kind of multimedia data can be avoided. This feature is expected to be extremely important for portable multimedia players such as the universal entertainment system of the present invention, in that the user does not need to carry different multimedia players for different multimedia materials.

In order to better facilitate outdoors use of the present invention, the entertainment unit 10 further comprises a remote operation system 14 and a power supply unit 15, wherein the remote operation system 14 comprises a remote sensor 141 provided on the entertainment housing 11 and electrically connected with the multi-functional multimedia circuitry 13, and a remote controller 142 adapted to deliver wireless signal, such as infrared radiation, for controlling an operation of the entertainment unit 10. The wireless signal is to be received by the remote sensor 141 which then transmits it to the multi-functional multimedia circuitry 13 for performing the relevant operation of the entertainment unit 10.

Obviously, as shown in FIG. 1A and FIG. 3 of the drawings, instead of replying on the remote operation system 14, the entertainment unit 10 further comprises a manual control panel 17 provided thereon and electrically connected with the multi-functional multimedia circuitry 13 for allowing the user to manually control the operation of the entertainment unit 10. Accordingly, the control panel 17 comprises the following non-exhaustive buttons: power on/off; mute; DVD/AV/TV selection; volume control; channel selection; play/pause; fast forwarding/backward (x2, x4, x8, x16); eject; and track selection.

The power supply unit 15 is preferably embodied as a rechargeable battery provided in the multimedia compartment of the entertainment housing 11 for supplying electrical energy to the multi-functional multimedia circuitry 13 and the display screen 12 for performing the multimedia materials. The power supply unit 15 may be recharged to provide electrical energy as a self-containing unit, or alternatively, it may be extended for connecting with an external power source through a power inlet 151 provided on the entertainment housing 11. As a preferred embodiment, the rechargeable battery can be a lithium-ion battery for approximately 2.5 hours usage. In other words, the present invention may be operated by DC rechargeable battery or AC power source connecting to an adaptor.

Furthermore, the entertainment unit 10 further comprises an audio output unit provided on the entertainment housing 11 for delivering audio data contained in the multimedia. Specifically, the audio output unit comprises a speaker 161 provided on the entertainment housing 11 and electrically connected with the multi-functional multimedia circuitry 13 in such a manner that audio data contained in the multimedia is first decoded by the multi-functional multimedia circuitry 13 and then outputted through the speaker 161. In addition, the audio output unit further comprises an audio jack 162 provided on the entertainment housing 11 and electrically connected with the multi-functional multimedia circuitry 13 for connecting with an external sound generator such as headsets or plug-in speakers so as to transmit audio signal in electronic form thereto.

Furthermore, the audio output unit may further comprise a wireless audio transmitter 163 provided on the entertainment unit 10 for wirelessly transmitting audio output signal to a wireless headset.

In relation to audio signal, the remote operation system 14 further comprises a wireless microphone 143 adapted to wirelessly transmit audio signal generated by the user to the multi-functional multimedia circuitry 13 so as to constitute a wireless karaoke system. Specifically, the wireless audio signal is transmitted from the wireless microphone 143 to the remote sensor 141 which is then transmitted to the multi-functional multimedia circuitry 13 for decoding and outputting to audience through the audio output unit. Moreover, the multi-functional multimedia circuitry 13 is also adapted to allow adjustment of singing key so as to suit different needs of different user. The user may adjust the singing key by controlling either the manual control panel 17 or the remote controller 142.

For enhanced application of the present invention, the entertainment unit 10 further comprises a lighting device 19 comprising two illuminators 191 respectively provided at the two corner portions of the rear side of the entertainment unit 10 for providing illumination at a predetermined light intensity, especially when the entertainment unit 10 is mounted to the roof or at the wall, wherein a user is able to control turning on or off the lighting device 19 via the manual control panel 17 or the remote operation system 14.

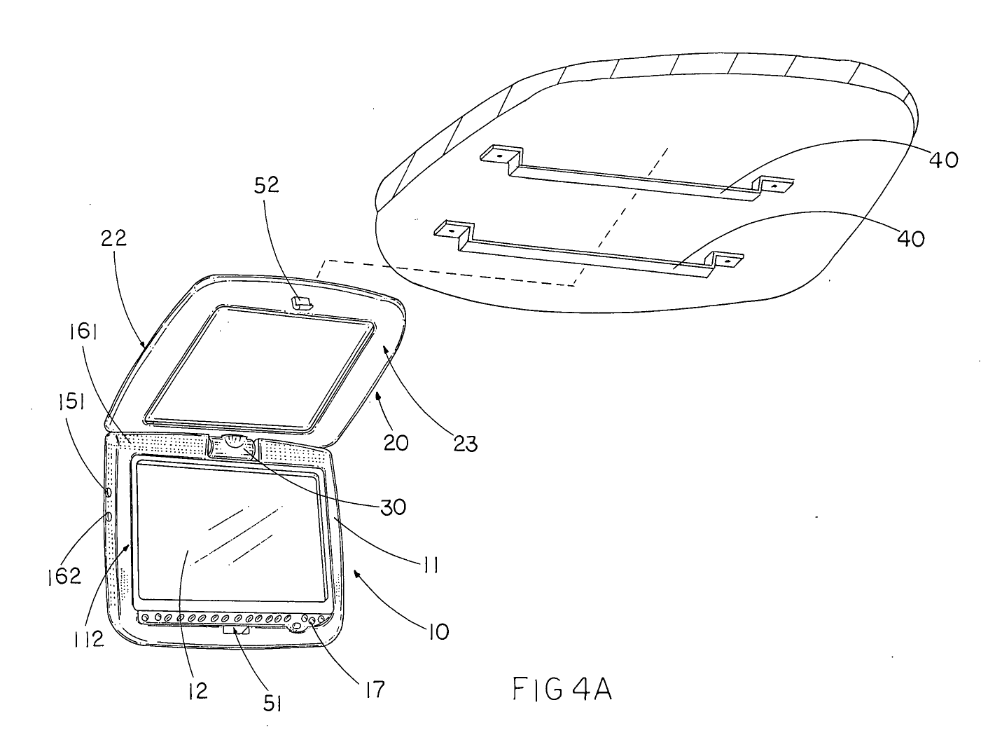

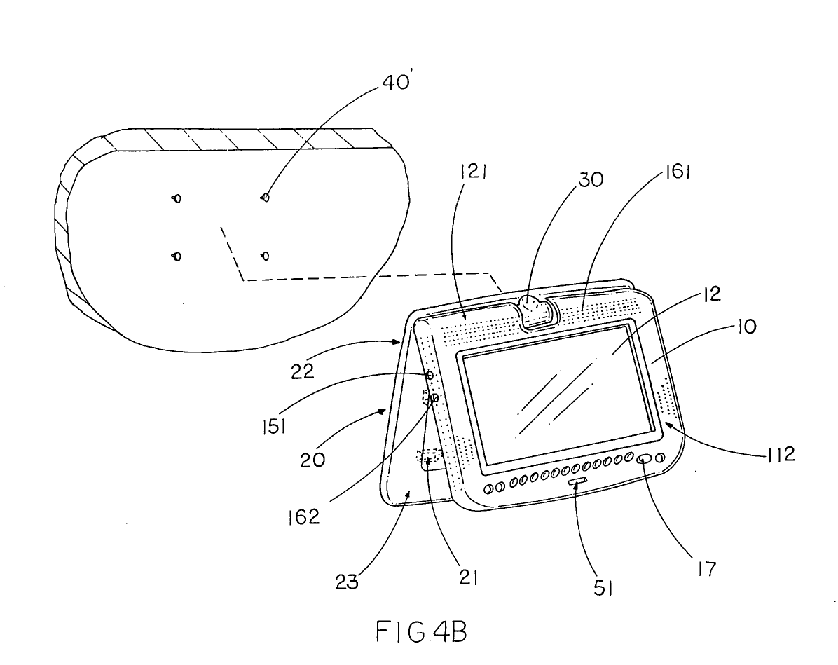

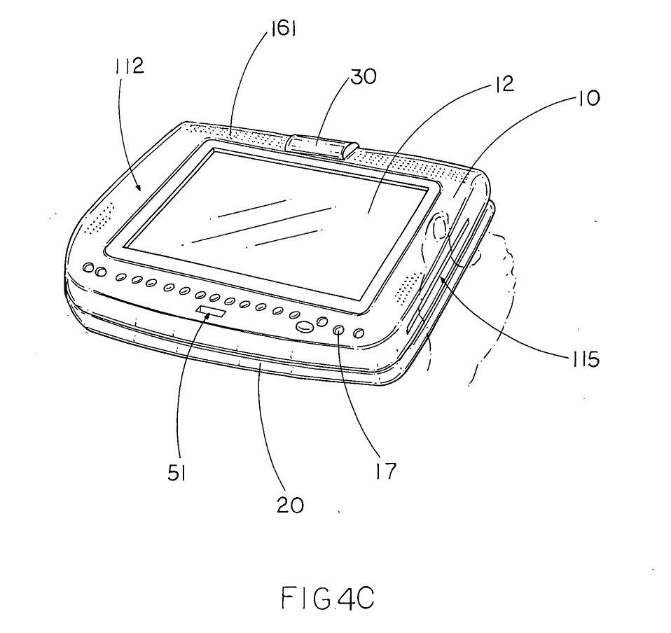

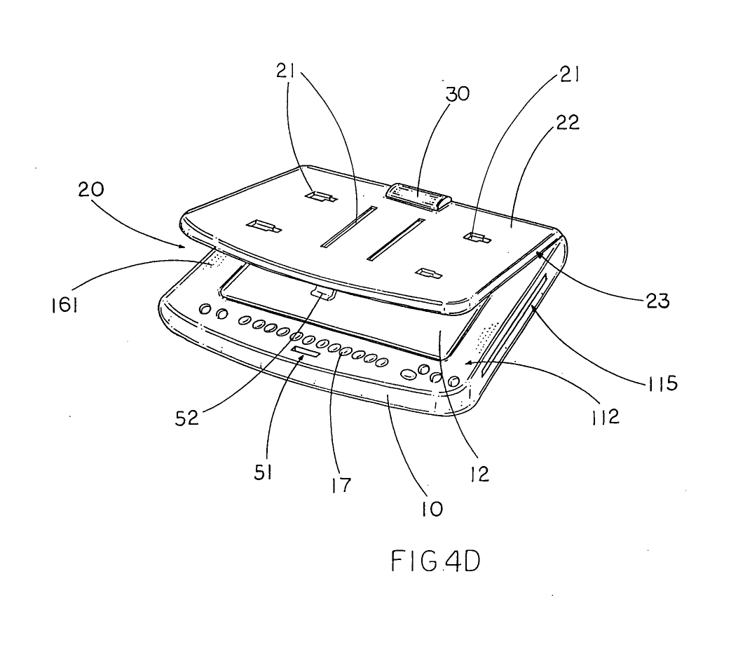

Referring to FIG. 2, FIG. 3, FIG. 4C and FIG. 4D of the drawings, the multimedia reader 131 communicates multimedia compartment with an exterior of the entertainment housing 11 through a multimedia slot 115 formed at a side edge portion thereof. Accordingly, the multimedia reader 131 comprises a multimedia loader 1311 provided at the multimedia slot 115 for loading and unloading a predetermined multimedia into the multimedia compartment in such a manner that the multimedia in question may be read by the multimedia reader 131. The multimedia loader 1311 is preferably embodied as a power-assisted auto slot-in loading system.

It is worth mentioning that the multimedia reader 131 is embodied as having anti-shock function for preventing interruption of reading multimedia materials when the entertainment unit 10 is subject to external vibration due to, for example, when it is operating in a moving car.

According to the preferred embodiment, the entertainment unit 10 further comprises a computer interface device 18 comprising at least one USB port 181 and an internet jack 182 provided on the entertainment housing 11 for connecting with a computing device in such a manner that the entertainment unit 10 can be utilized for displaying multimedia materials in conjunction with a computer.

The display screen 12 is preferably embodied as a LCD panel having the following technical specification:
Screen size: 10.2 inches;
Body size: 25.2 cm×20.7 cm×3.3 cm;
Configuration: RGB stripe;
Pixel pitch (W×H): 0.2775 mm×0.2775 mm;
Display area: (W×H): 220 mm×133.2 mm;
Resolution: 852 (GRB)×480;
Display color: 6 bits, 262K;
Audio input signal: 30 to 100 m Vp-p
Video input signal: 1.0 Vp-p composite video;
Video system: NTSC/PAL auto switch;
Brightness: 400 cd/m²;
Contrast ratio: 300:1;
16:9 wide screen display;
Cable TV input;
FM Modulation;
OSD control function; and
Adjustable color base.

Referring to FIG. 4A to FIG. 4D of the drawings, four schematic diagrams illustrating different applications of the universal entertainment system according to the preferred embodiment of the present invention are shown. It is important to realize at the outset that the universal entertainment system is adapted for mounting in differing circumstances so as to achieve different applications.

For example, as shown in FIG. 4A of the drawings, the universal mounting stand 20 is adapted to ride on a supporting hanger 40 which is downwardly extended from a ceiling so that the entertainment unit 10 is capable of unfolding at the tilt angle from the universal mounting stand 20 so as to uprightly suspend from the ceiling. Accordingly, the multi-functional multimedia circuitry 13 further comprises an image reverse circuitry 132 incorporated therewith for reversing the image shown on the display screen 12. Thus, when the entertainment unit 10 is uprightly supported from a ceiling, as in FIG. 4A, the image reverse circuitry 132 is arranged to reverse the image shown on the display screen 12 so as to align the image with the orientation of the entire entertainment unit 10.

Referring to FIGS. 1B and 4B of the drawings, the entertainment unit 10 is adapted to mount on a wall for displaying the multimedia materials. Accordingly, the universal mounting stand 20 further has a plurality of mounting slots 21 spacedly formed at the mounting side 22 of the universal mounting stand 20 for a supporting hanger 40′ of the fixture surface 121, such as a wall, coupling thereto so as to suspendedly hang the universal entertainment system on that external fixture. As shown in FIG. 4B, the supporting hanger 40′ can be a mounting pin or a screw extended from the wall for coupling with the corresponding mounting slot 21. Note that when the universal mounting stand 20 is mounted on the external fixture, such as the wall, the user may need to flip over the entertainment unit 10 for achieving an optimal orientation.

Referring to FIG. 1A, FIG. 4C and FIG. 4D of the drawings, the universal mounting stand 20 is overlappedly folded with the entertainment housing 11 so as to form a compact structure for handheld operation for say, hand carrying. Accordingly, the universal entertainment system further comprises means for detachably locking the entertainment unit 10 with the universal mounting stand 20. The locking means consists at least an elongated locking slot 51 indently formed on the universal mounting stand 20, preferably at the fixture surface 121, and comprises a locking arm 52 upwardly extended from and slidably connected to the entertainment housing 11 at a position corresponding to the elongated locking slot 51 such that the locking arm 52 is adapted to receive in the locking slot 51 and sidewardly slide to engage with a sidewall of the locking slot 51 so as to interlock a lateral pivotal movement between the universal mounting stand 20 and the entertainment unit 10.

It is then worth mentioning that the locking slot 51 may be formed at both sides of the universal mounting stand 20 such that the locking arm 52 may selectively lock at either side of the universal mounting stand 20 so as to either hide the display screen 12 between the entertainment housing 11 and the universal mounting stand 20 (FIG. 4D), or to expose the display screen 12 outwardly for handheld playing of predetermined multimedia materials (FIG. 4C).

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A universal entertainment system, comprising:
an entertainment unit which comprises an entertainment housing having a multimedia compartment and a screen side, a display screen provided on said screen side of said entertainment housing, and a multi-functional multimedia circuitry which is disposed in said multimedia compartment and comprises a multimedia reader for reading digital data of a multimedia when said multimedia is received in said multimedia compartment so as to display said digital data of said multimedia as a video image on said display screen; and
a universal mounting stand adapted for supporting at a fixture surface; and
a folding joint pivotally connecting said entertainment unit with said universal mounting stand in a rotatably movable manner, wherein said entertainment unit is adapted to pivotally fold with respect to said universal mounting stand to selectively adjust a tilt angle of said display screen with respect to said fixture surface and is adapted to rotatably fold with respect to said universal mounting stand to selectively adjust a revolving angle with respect to said universal mounting stand such that said entertainment unit is adapted to selectively adjust an optimal display orientation of said display screen with respect to said fixture surface.

2. The universal entertainment system, as recited in claim 1, wherein said universal mounting stand having a mounting side for mounting on said fixture surface and an opposed covering side sized at least larger than a size of said display screen such that said universal mounting stand also forms a protective cover pivotally folded to overlap said covering side thereof on said display side of said entertainment housing to enclose said display screen so as to protect said display screen from exposing to outside.

3. The universal entertainment system, as recited in claim 1, wherein said folding joint has a folding slot indently formed at a side edge of said entertainment housing and comprises a joint body which is provided at a corresponding side edge of said universal mounting stand and is rotatably engaged with said folding slot to pivotally connect said universal mounting stand with said entertainment housing so as to selectively adjust said tilt angle between said display screen and said universal mounting stand.

4. The universal entertainment system, as recited in claim 2, wherein said folding joint has a folding slot indently formed at a side edge of said entertainment housing and comprises a joint body which is provided at a corresponding side edge of said universal mounting stand and is rotatably engaged with said folding slot to pivotally connect said universal mounting stand with said entertainment housing so as to selectively adjust said tilt angle between said display screen and said universal mounting stand.

5. The universal entertainment system, as recited in claim 3, wherein said folding slot further comprises two pivotal shafts transversely extended from two sidewalls of said folding slots to frictionally insert into two holding grooves at two sidewalls of said joint body to pivotally connect said universal mounting stand with said entertainment housing so as to selectively adjust said tilt angle thereof.

6. The universal entertainment system, as recited in claim 4, wherein said folding slot further comprises two pivotal shafts transversely extended from two sidewalls of said folding slots to frictionally insert into two holding grooves at two sidewalls of said joint body to pivotally connect said universal mounting stand with said entertainment housing so as to selectively adjust said tilt angle thereof.

7. The universal entertainment system, as recited in claim 3, wherein said folding joint further comprises a revolving connector extended from said side edge of said universal mounting stand to transversely engage with said joint body in a rotatably movable manner so as to rotatably connect said universal mounting stand with said entertainment housing to selectively adjust said revolving angle thereof.

8. The universal entertainment system, as recited in claim 4, wherein said folding joint further comprises a revolving connector extended from said side edge of said universal mounting stand to transversely engage with said joint body in a rotatably movable manner so as to rotatably connect said universal mounting stand with said entertainment housing to selectively adjust said revolving angle thereof.

9. The universal entertainment system, as recited in claim 6, wherein said folding joint further comprises a revolving connector extended from said side edge of said universal mounting stand to transversely engage with said joint body in a rotatably movable manner so as to rotatably connect said universal mounting stand with said entertainment housing to selectively adjust said revolving angle thereof.

10. The universal entertainment system, as recited in claim 2, wherein said multi-functional multimedia circuitry further comprises an image reverse circuitry incorporated therewith for reversing said video image on said display screen in an upside down manner when universal mounting stand is arranged for mounting on said fixture surface to suspendedly support said entertainment unit in an upside down manner.

11. The universal entertainment system, as recited in claim 6, wherein said multi-functional multimedia circuitry further comprises an image reverse circuitry incorporated therewith for reversing said video image on said display screen in an upside down manner when universal mounting stand is arranged for mounting on said fixture surface to suspendedly support said entertainment unit in an upside down manner.

12. The universal entertainment system, as recited in claim 9, wherein said multi-functional multimedia circuitry further comprises an image reverse circuitry incorporated therewith for reversing said video image on said display screen in an upside down manner when universal mounting stand is arranged for mounting on said fixture surface to suspendedly support said entertainment unit in an upside down manner.

13. The universal entertainment system, as recited in claim 2, wherein said universal mounting stand further has a plurality of mounting slots indently and spacedly formed at said mounting side for a supporting hanger on said fixture surface coupling thereto so as to suspendedly hang said universal entertainment system on said fixture surface.

14. The universal entertainment system, as recited in claim 9, wherein said universal mounting stand further has a plurality of mounting slots indently and spacedly formed at said mounting side for a supporting hanger on said fixture surface coupling thereto so as to suspendedly hang said universal entertainment system on said fixture surface.

15. The universal entertainment system, as recited in claim 12, wherein said universal mounting stand further has a plurality of mounting slots indently and spacedly formed at said mounting side for a supporting hanger on said fixture surface coupling thereto so as to suspendedly hang said universal entertainment system on said fixture surface.

16. The universal entertainment system, as recited in claim 6, wherein said entertainment unit further comprises a remote operation system comprising a remote sensor which is provided on said entertainment housing and is electrically connected with said multi-functional multimedia circuitry, and a remote controller delivering a wireless signal to communicate with said remote sensor so as to wirelessly control an operation of said entertainment unit.

17. The universal entertainment system, as recited in claim 15, wherein said entertainment unit further comprises a remote operation system comprising a remote sensor which is provided on said entertainment housing and is electrically connected with said multi-functional multimedia circuitry, and a remote controller delivering a wireless signal to communicate with said remote sensor so as to wirelessly control an operation of said entertainment unit.

18. The universal entertainment system, as recited in claim 16, wherein said remote operation system further comprises a wireless microphone communicating with said remote sensor for wirelessly transmitting audio signal to said multi-functional multimedia circuitry so as to constitute a wireless karaoke system.

19. The universal entertainment system, as recited in claim 17, wherein said remote operation system further comprises a wireless microphone communicating with said remote sensor for wirelessly transmitting audio signal to said multi-functional multimedia circuitry so as to constitute a wireless karaoke system.

20. The universal entertainment system, as recited in claim 17, wherein said entertainment unit further comprises a power supply unit embodied as a rechargeable battery provided in said multimedia compartment of said entertainment housing for supplying electrical energy to said multi-functional multimedia circuitry and said display screen for displaying said multimedia materials, wherein said rechargeable battery is adapted to provide electrical energy as a self-containing unit, and extend for connecting with an external power source through a power inlet provided on said entertainment housing.

21. The universal entertainment system, as recited in claim 19, wherein said entertainment unit further comprises a power supply unit embodied as a rechargeable battery provided in said multimedia compartment of said entertainment housing for supplying electrical energy to said multi-functional multimedia circuitry and said display screen for displaying said multimedia materials, wherein said rechargeable battery is adapted to provide electrical energy as a self-containing unit, and extend for connecting with an external power source through a power inlet provided on said entertainment housing.

22. The universal entertainment system, as recited in claim 17, wherein said entertainment unit further comprises an audio output unit provided on said entertainment housing for delivering audio data contained in the multimedia, wherein said audio output unit comprises at least a speaker provided on said entertainment housing for generating audio sound effect corresponding with said audio signal in said multimedia, and an audio jack provided on said entertainment housing for connecting with an external sound generator.

23. The universal entertainment system, as recited in claim 21, wherein said entertainment unit further comprises an audio output unit provided on said entertainment housing for delivering audio data contained in the multimedia, wherein said audio output unit comprises at least a speaker provided on said entertainment housing for generating audio sound effect corresponding with said audio signal in said multimedia, and an audio jack provided on said entertainment housing for connecting with an external sound generator.

24. The universal entertainment system, as recited in claim 17, wherein said entertainment unit further comprises a computer interface device comprising at least one USB port and an internet jack provided on said entertainment housing for connecting with a computer in such a manner that said entertainment unit is adapted for displaying multimedia materials in conjunction with said computer.

25. The universal entertainment system, as recited in claim 23, wherein said entertainment unit further comprises a computer interface device comprising at least one USB port and an internet jack provided on said entertainment housing for connecting with a computer in such a manner that said entertainment unit is adapted for displaying multimedia materials in conjunction with said computer.
